(19) United States
(12) Patent Application Publication
(10) Pub. No.: US 2026/0211655 A1
(43) Pub. Date: Jul. 23, 2026

(54) MANAGING SETS OF TASKS FOR UPDATING SOFTWARE BASED ON CHANGE MAGNITUDES

(71) Applicant: Dell Products L.P., Round Rock, TX (US)

(72) Inventors: BORIS SHPILYUCK, Ashdod (IL); YONIT LOPATINSKI, Shomria (IL); OR HERMAN SAFFAR, Ofakim (IL); JEHUDA SHEMER, Kfar Saba (IL); OFIR EZRIELEV, Be'er Sheva (IL)

(21) Appl. No.: 19/033,092

(22) Filed: Jan. 21, 2025

(51) Int. Cl. G06F 8/65

(52) U.S. Cl. CPC G06F 8/65

(57) ABSTRACT

Methods and systems for providing computer-implemented services using a data processing system are disclosed. To provide the computer-implemented services, a set of tasks to implement a modification to a codebase for a portion of software may be obtained. The set of tasks and at least one trained machine learning model may be used to estimate a change magnitude of changes to the codebase required to complete the modification. The estimated change magnitude and software update criteria may be used to determine whether the set of tasks is acceptable. If the set of tasks is acceptable, an update process may be initiated for the software to obtain updated software and the updated software may be deployed to facilitate provisioning of desired computer-implemented services.

### FIELD

Embodiments disclosed herein relate generally to managing software updates. More particularly, embodiments disclosed herein relate to systems and methods to manage sets of tasks for updating software based on change magnitudes.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIG. 2D shows an example task and task description in accordance with an embodiment.

FIGS. 3A-3C show flow diagrams illustrating a method for providing computer-implemented services in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using a data processing system. To provide the computer-implemented services to a downstream consumer, the data processing system may include any number of hardware components, such as processors, memory modules, storage devices, communication devices, etc. The hardware components of the data processing system may support execution of any number and/or type of software components (e.g., software programs). Changes in available functionalities of the hardware components and/or the software components of the data processing system may provide for various types of different computer-implemented services to be provided to the downstream consumer.

Over time, the software components of the data processing system may be modified. For example, a software program hosted by the data processing system may be updated to improve performance of the data processing system, add functionality to the data processing system, reduce a security risk associated with the software program, etc. Updates and/or other modifications made to the software components of the data processing system may allow for additional computer-implemented services to be provided, more reliable computer-implemented services to be provided, the computer-implemented services to be provided in a more secure manner, and/or other improvements to the computer-implemented services provided to the downstream consumer.

To modify a software program (e.g., software) of the data processing system, a set of tasks may be obtained based on an updated technical specification for the software. The updated technical specification may indicate one or more desired functionalities to be included in an updated version of the software that are not available in a current version of the software. The set of tasks may include actions to be performed to fulfill the updated technical specification.

The set of tasks may be used to obtain a set of changes to a codebase for the software and the software may be updated by integrating the set of changes into the codebase.

However, integrating the set of changes into the codebase may have undesired impacts on the software program. For example, the changes may introduce bugs and/or errors into the software program, reduce maintainability of the software program, introduce compatibility and/or performance issues, introduce security issues (e.g., introduce new security vulnerabilities and/or expose existing security vulnerabilities), and/or result in other undesired impacts on the software program. Consequently, the computer-implemented services provided to the downstream consumer using the software program may be delayed, provided in a manner that does not meet the expectations of the downstream consumer, and/or may otherwise be negatively impacted.

To reduce a likelihood of errors being introduced to the codebase and/or other undesired impacts on the functionality of the software program, the set of tasks may be evaluated prior to generating the set of changes to the codebase (e.g., prior to assigning the set of tasks to programmers, engineers and/or other subject matter experts (SMEs)). Evaluating the set of tasks may include estimating a change magnitude of changes to the codebase required to complete the desired modification to the codebase using at least one trained machine learning model. The change magnitude may indicate a level of change (e.g., a degree of impact) to operation of the software should the software be updated based on the modification to the codebase.

The at least one machine learning model may be trained to predict change magnitudes based on sets of tasks and may output the estimated change magnitude. The at least one machine learning model may also include a large language model (LLM) trained to generate provisional sets of changes to the codebase based on sets of tasks and, therefore, may generate a provisional set of changes based on the ingested set of tasks. If the provisional set of changes are obtained, the estimated change magnitude may be obtained based on the provisional set of changes.

The estimated change magnitude and software update criteria may be used to determine whether the set of tasks is acceptable (e.g., the change magnitude may be compared to a change magnitude threshold indicated by the software update criteria). If the set of tasks is acceptable, an update process may be initiated for the software (e.g., the set of tasks may be assigned, a set of changes may be obtained in response to the assignment of the set of tasks), and the software may be updated. The updated software may be deployed to facilitate provisioning of desired computer-implemented services.

If the set of tasks is not acceptable, the set of tasks may be rejected for use in updating the software. A process may be initiated to remediate the rejection of the set of tasks (e.g., one or more tasks of the set of tasks may be broken down into multiple sets of tasks to reduce the change magnitude of each individual set of tasks). By doing so, the impact associated with the changes to the codebase for each set of tasks may be reduced.

Thus, embodiments disclosed herein may address, among other technical problems, the technical challenge of integrating sets of changes into codebases. By estimating change magnitudes associated with sets of tasks, sets of tasks that may produce undesirably large changes to operation of the software if completed may be identified and remediated (e.g., broken up into smaller sets of tasks). Doing so may reduce a likelihood of errors being introduced into the codebase and/or other undesired impacts on the functionality of the software program. Consequently, a likelihood of providing the computer-implemented services using the software program in a manner that meets the expectations of a downstream consumer of the computer-implemented services may be improved.

In an embodiment, a method for providing computer-implemented services using a data processing system is disclosed. The method may include: obtaining a set of tasks to implement a modification to a codebase for software so that an updated version of the software based on the modified codebase has at least one desired functionality that is not available in an original version of the software; estimating, using the set of tasks and at least one trained machine learning model, a change magnitude of changes to the codebase required to complete the modification, the estimated change magnitude indicating a level of change to operation of the software should the software be updated based on the modification to the codebase; making a determination, using the estimated change magnitude and software update criteria, regarding whether the set of tasks is acceptable; in a first instance of the determination in which the set of tasks is acceptable: initiating, based on the set of tasks, an update process for the software to obtain the updated version of the software; and deploying the updated version of the software to facilitate provisioning of desired computer-implemented services.

The method may also include: in a second instance of the determination in which the set of tasks is not acceptable: rejecting the set of tasks for use in updating the software.

Estimating the change magnitude may include: obtaining task descriptions for the set of tasks; and using the task descriptions as ingest for the at least one trained machine learning model to obtain the estimated change magnitude as an output from the at least one trained machine learning model.

Each task description of the task descriptions may include at least one characteristic selected from a list of characteristics consisting of: a number of words in a task of the set of tasks; a number of bullet points in the task; a degree of nesting of the bullet points in the task; keywords included in the task; degrees of technical complexity associated with each of the keywords; and a number of links to other tasks of the set of tasks.

The trained machine learning model may be trained using historical software update data. The historical software update data may include descriptions of completed tasks and corresponding change magnitudes for software updated based on the completed tasks.

The trained machine learning model may be a large language model (LLM) trained to generate provisional sets of changes to the codebase based on sets of tasks.

Estimating the change magnitude may include: obtaining, using the set of tasks as input for the LLM, a provisional set of changes to the codebase as an output from the LLM, the provisional set of changes being usable to complete the set of tasks; and obtaining, based on the provisional set of changes, the estimated change magnitude.

The provisional set of changes may include potential changes to at least a portion of the codebase usable to complete the set of tasks.

The software update criteria may include a change magnitude threshold.

The change magnitude exceeding the change magnitude threshold may indicate integrating the changes to the codebase required to complete the modification has an unacceptable risk of undesired impacts on instances of the software obtained from the integrated codebase.

The change magnitude may be a weighted sum of a criticality value and a similarity value.

The criticality value may indicate a degree of impact of integrating the changes into the codebase. The degree of impact may be based on a number of application programming interfaces (APIs) impacted by the changes.

The similarity value may be based on a difference between a first summary of the changes and a second summary of the at least a portion of codebase for the software.

The codebase may include source code for the software.

The method may also include: prior to obtaining the set of tasks: making an identification that an updated functional specification is available for the software, the updated functional specification indicating the at least one desired functionality.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

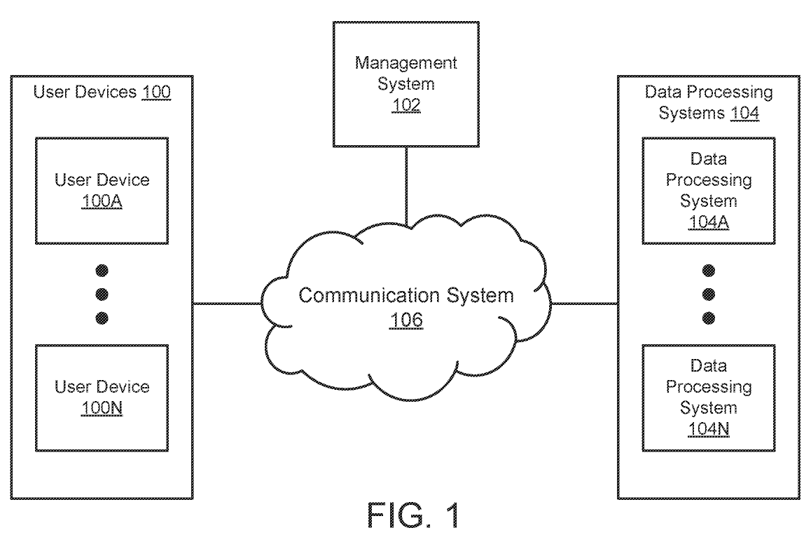

Turning to FIG. 1, a block diagram illustrating a system in accordance with an embodiment is shown. The system shown in FIG. 1 may provide computer-implemented services. The computer implemented services may include any type and quantity of computer-implemented services. For example, the computer-implemented services may include data storage services, instant messaging services, database services, and/or any other type of service that may be implemented with a computing device. Other types of computer-implemented services may be provided by the system without departing from embodiments disclosed herein.

The computer-implemented services may be provided using data processing systems 104 (and/or other devices) to any number of downstream consumers of the computer-implemented services (e.g., users of data processing systems 104 such as businesses and/or individuals). Data processing systems 104 may include any number of hardware components, such as processors, memory modules, storage devices, communication devices, etc. The hardware components of data processing systems 104 may support execution of any number and/or type of software components (e.g., applications and/or other types of software programs). Changes in available functionalities of the hardware components and/or the software components of data processing systems 104 may provide for various types of different computer-implemented services to be provided to the downstream consumers.

Over time, the software components of data processing systems 104 may be modified. For example, portions of the software components may be updated to improve performance of data processing systems 104, add functionality to data processing systems 104, reduce a security risk associated with a portion of the software components, etc. Updates and/or other modifications made to the software components of data processing systems 104 may allow for additional computer-implemented services to be provided, more reliable computer-implemented services to be provided, the computer-implemented services to be provided in a more secure manner, and/or other improvements to the computer-implemented services provided to the downstream consumers.

To modify the software components of data processing systems 104, the system may include any number of user devices 100. User devices 100 may be used by users such as programmers, developers, engineers, and/or other users to generate, update, modify, and/or otherwise manage at least a portion of the software components (e.g., software programs) of data processing systems 104 to complete a set of tasks based on an updated functional specification for a software program.

For example, the updated functional specification may indicate that a pop-up functionality is desired to be added to the software program so that a pop-up window will appear on a user’s device when a user selects (e.g., using a human interface device such as a mouse or a trackpad) an icon on a graphical user interface (GUI) for the software program. The set of tasks to fulfill the updated functional specification may, therefore, include adding a pop-up window that is to be displayed when the icon is selected. The set of tasks may also include adding text to be displayed on the popup window and/or other tasks. The set of tasks may be assigned to users of user devices 100 and the users may utilize user devices 100 to generate the set of changes to modify the codebase and complete the set of tasks. The set of changes may be used to update the software program by integrating the set of changes to the codebase for the software program.

However, integrating the changes into the codebase may have undesired impacts on the software program. For example, the changes may introduce bugs and/or errors into the software program, reduce maintainability of the software program, introduce compatibility and/or performance issues, introduce security issues (e.g., introduce new security vulnerabilities and/or expose existing security vulnerabilities), and/or result in other undesired impacts on the software program. Consequently, the computer-implemented services provided to the downstream consumers using the software program may be delayed, provided in a manner that does not meet the expectations of the downstream consumers, and/or may otherwise be negatively impacted.

In general, embodiments disclosed herein may provide methods, systems, and/or devices for integrating changes to source code for a software program into a codebase in a manner that reduces a likelihood of negatively impacting computer-implemented services provided using the software program. To do so, a set of tasks usable to accomplish a desired modification to the software program may be obtained. Using the set of tasks and at least one trained machine learning model, a change magnitude may be estimated for a set of changes to the codebase required to complete the desired modification. The estimated change magnitude may indicate a level of change (e.g., an impact) to operation of the software should the software be updated based on the modification to the codebase.

The trained machine learning model may be trained using historical software update data that relates sets of tasks to corresponding change magnitudes. The trained machine learning model may, therefore, ingest the set of tasks and may generate, as an output, the estimated change magnitude.

The trained machine learning model may be an LLM trained to generate provisional sets of changes to the codebase in response to a prompt. The estimated change magnitude may be generated based on the provisional set of changes.

The estimated change magnitude and software update criteria may be used to determine whether the set of tasks is acceptable (e.g., is approved for use in generating changes to the codebase). Determining whether the set of tasks is acceptable may include comparing the estimated change magnitude to a change magnitude threshold included in the software update criteria and/or other methods.

If the set of tasks is acceptable, an update process may be initiated based on the set of tasks (e.g., the set of tasks may be assigned to users of user devices 100) to obtain the updated version of the software (e.g., a set of changes may be obtained and integrated into the codebase). The updated version of the software may be deployed to facilitate provisioning of desired computer-implemented services based, at least in part, on the desired functionality indicated by the updated functional specification.

If the set of tasks is not acceptable, the set of tasks may be rejected for use in updating the software. In addition, the rejection may be remediated (e.g., one or more of the set of tasks may be broken into multiple smaller sets of tasks).

By doing so, embodiments disclosed herein may reduce a likelihood of errors being introduced into the codebase and/or other undesired impacts on the functionality of the software program. As a result, a likelihood of providing the computer-implemented services in a manner that meets the expectations of downstream consumers of the computer-implemented services may be improved.

To provide the above noted functionality, the system of FIG. 1 may include user devices 100, management system 102, data processing systems 104, and communication system 106. Each of these components is discussed below.

Data processing systems 104 may include any number and/or type of data processing systems (e.g., 104A-104N). Each data processing system of data processing systems 104 may include hardware and/or software components (e.g., software programs) configured to facilitate the provision of all, or a portion of, the computer-implemented services to downstream consumers of the computer-implemented services (e.g., users of data processing systems 104). The downstream consumers may include, for example, businesses, individuals, and/or other users that may consume computer-implemented services provided using data processing systems 104.

For example, a data processing system (e.g., data processing system 104A) may be used by a hospital (e.g., a downstream consumer) to store patient information. The computer-implemented services provided using data processing system 104A may include secure data storage services, which may be facilitated using a security program (e.g., a software component of data processing system 104A). The security program may be used to encrypt the patient information, regulate access to the patient information, and/or otherwise protect the patient information from being accessed by unauthorized entities.

The software programs may be updated, modified, and/or otherwise maintained using user devices 100. User devices 100 may include any type and/or quantity of user devices (e.g., 100A-100N), which may include data processing systems and/or other computing devices. Users of user devices 100 may have various roles related to maintaining and/or modifying the functionality software programs of data processing systems 104. For example, the user roles may include writing initial source code for the software programs, identifying functionalities (e.g., desired by the downstream consumers) to be added to the software programs, identifying security vulnerabilities of the software programs, obtaining sets of changes for codebases associated with the software programs based on sets of tasks assigned to the users of user devices 100, and/or performing other tasks.

The sets of changes may be obtained (e.g., responsive to a set of tasks intended to accomplish a desired modification to the software) to: (i) address bugs and/or other errors in the source code (e.g., that cause the software programs to operate in unexpected and/or undesired manners), (ii) improve performance of the software programs (e.g., to allow the software programs to run faster, use less memory, and/or consume fewer resources), (iii) address security vulnerabilities, (iv) add the desired functionalities to the software programs, (iv) adapt to changes in underlying environments and/or technologies used by the software programs, and/or (v) otherwise improve and/or maintain the software programs.

Returning to the above example, the security program used to provide the secure data storage services may be updated to improve security of the patient information and/or add functionality to the security program, such as additional authentication procedures to reduce a likelihood of the patient information being accessed by unauthorized users. A set of changes may be generated using user device 100A to update the source code of the codebase for the security program.

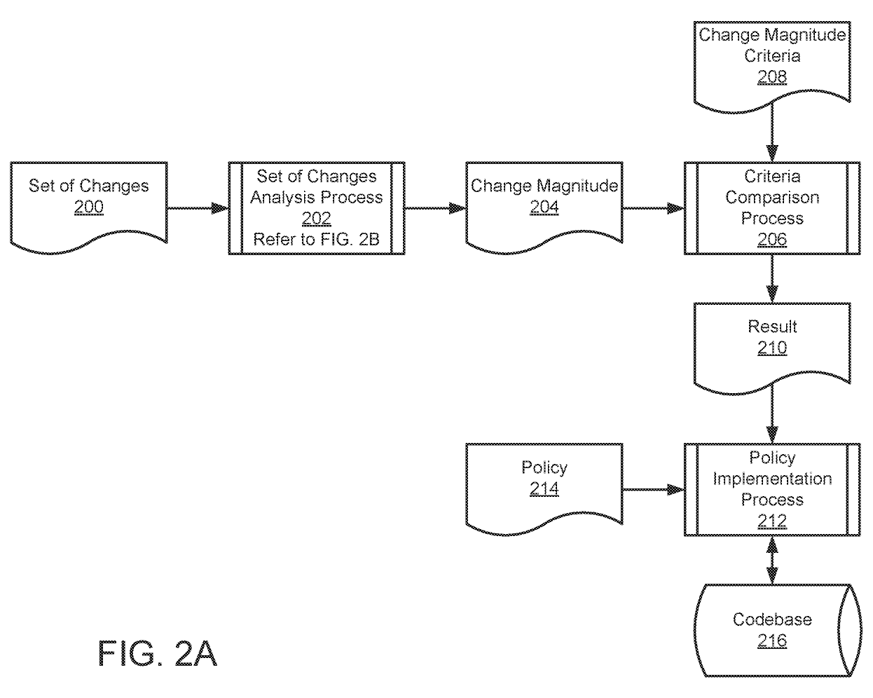

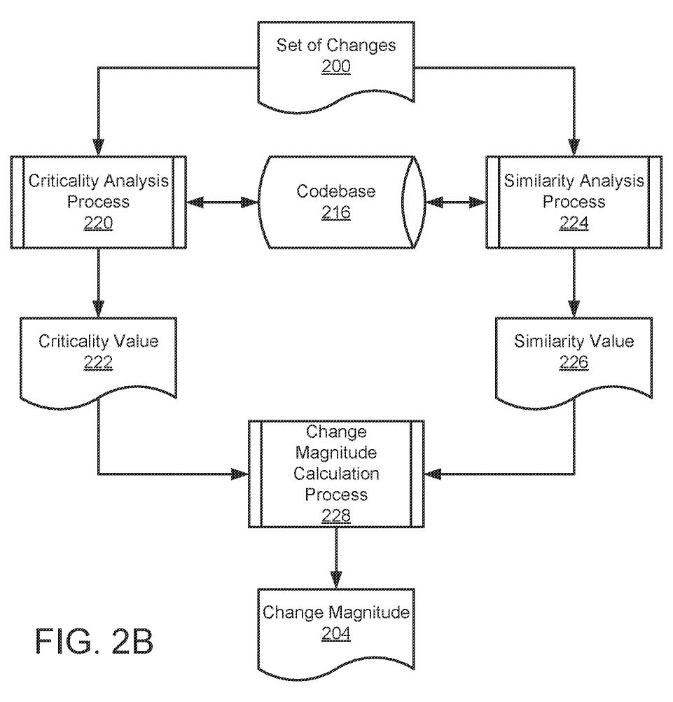

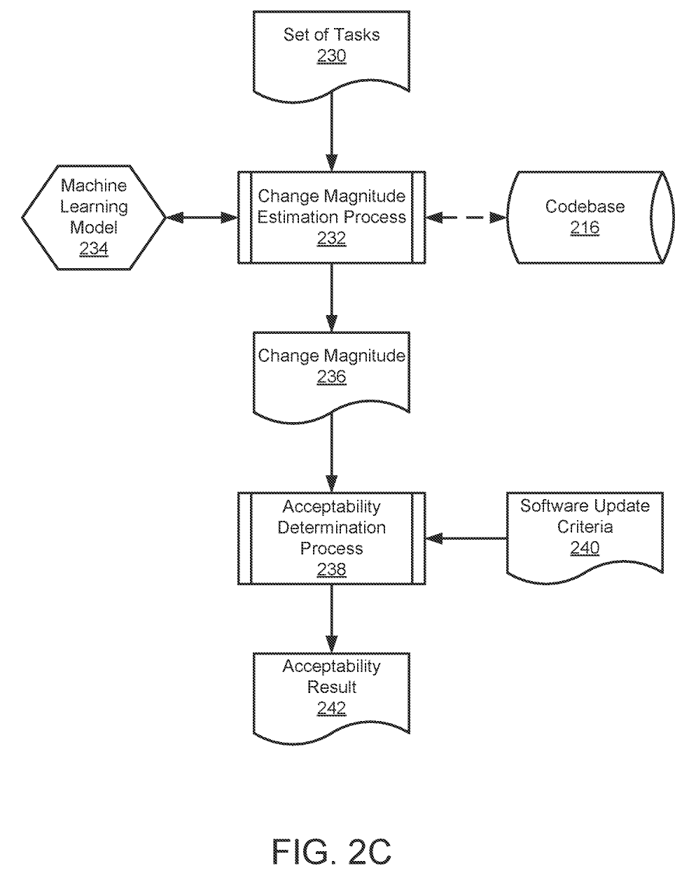

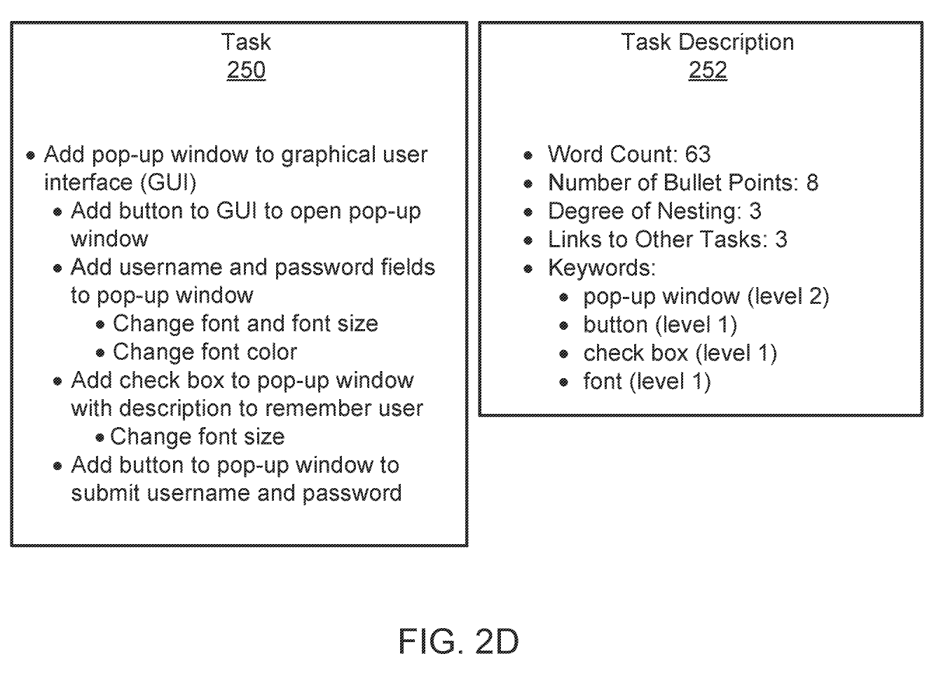

User devices 100 may be managed by management system 102. Management system 102 may include any number and/or type of devices (e.g., data processing systems) used to manage codebases and/or tasks performed by user devices 100 related to the codebases. For example, management system 102 may: (i) obtain a sets of tasks to implement a modification to a codebase (e.g., based on an updated functional specification for a portion of software), (ii) estimate change magnitudes for changes to the codebase required to complete the modification using the set of tasks and at least one trained machine learning model, (iii) determine whether the set of tasks is acceptable, (iv) obtain a set of changes based on the set of tasks (e.g., if the set of tasks is acceptable), (v) perform analysis processes for the set of changes, (vi) manage integration of the set of changes into the codebases (e.g., based on policies for managing codebases), (vii) perform tasks related to maintaining the codebases, and/or (viii) perform other tasks to facilitate provision of the computer-implemented services using the software programs used by data processing systems 104. Refer to FIG. 2C for additional details regarding estimating change magnitudes.

By performing its functionality, management system 102 may reduce a likelihood of undesired impacts on the software programs as a result of integrating sets of changes into the codebases. Refer to the description of FIGS. 2A-2B for additional details regarding analysis of sets of changes and integration of sets of changes into codebases. Refer to FIG. 2C for additional details regarding evaluating sets of tasks (e.g., via estimating change magnitudes using at least one trained machine learning model) prior to using the sets of tasks to obtain the sets of changes.

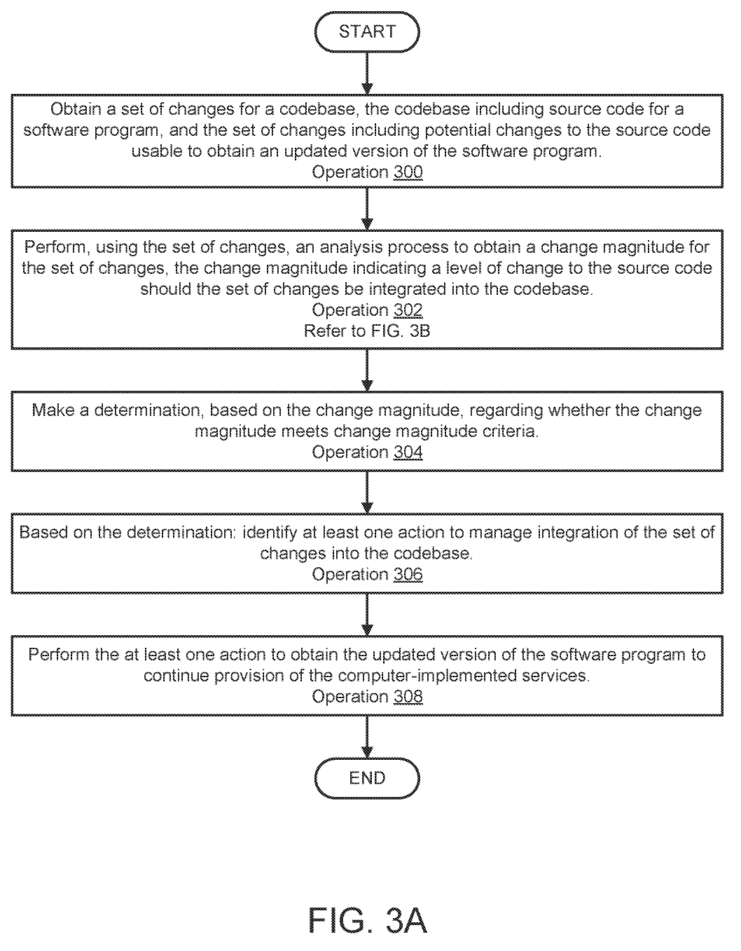

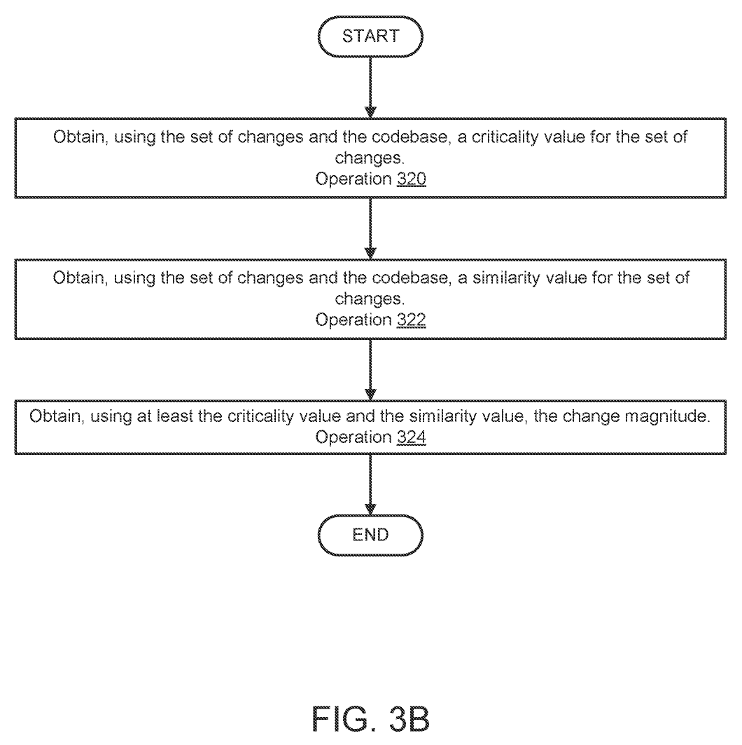

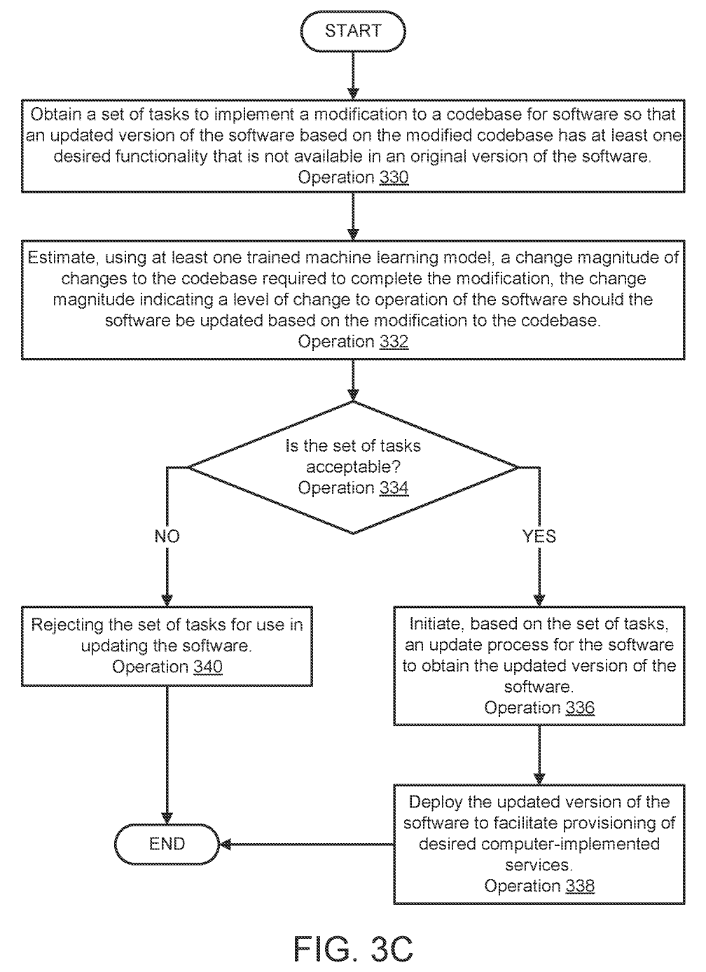

When providing their functionality, any of (and/or components thereof) user devices 100, management system 102, and/or data processing systems 104 may perform all, or a portion, of the actions and methods illustrated in FIGS. 2A-3C.

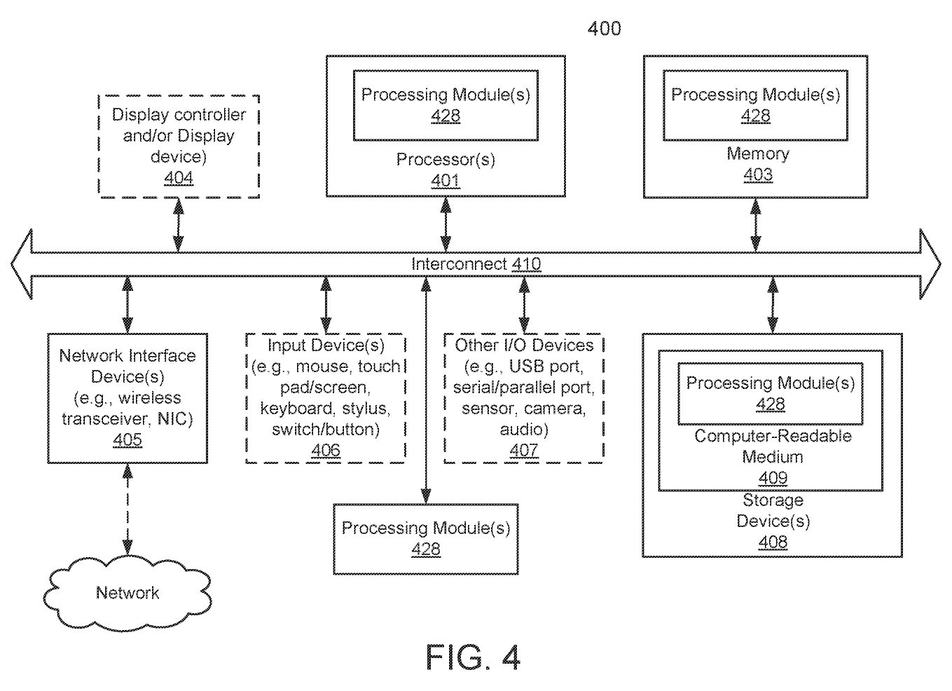

Any of (and/or components thereof) user devices 100, management system 102, and/or data processing systems 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Management system 102 may be implemented with multiple computing devices. The computing devices of management system 102 may cooperatively perform processes for managing codebases. The computing devices of management system 102 may perform similar and/or different functions, and may be used by different persons (e.g., users) that may participate in the management of codebases. For example, management system 102 may include multiple computing devices used by managers, programmers, developers, engineers, and/or other users (e.g., persons) tasked with managing codebases.

Management system 102 may be maintained, for example, by a business or other entity that has some degree of responsibility with respect to managing the operation of user devices 100. For example, management system 102 may be operated by a software company that employs and/or otherwise cooperates with users of user devices 100.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

The system described in FIG. 1 may be used to facilitate provision of computer-implemented services using a data processing system. The following processes described in FIGS. 2A-2C may be performed by the system in FIG. 1 when providing this functionality.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 204, etc.) is used to represent data structures, a second set of shapes (e.g., 202, 206, etc.) is used to represent processes performed using and/or that generate data, and a third set of shapes (e.g., 216) is used to represent large scale data structures such as databases.

Turning to FIG. 2A, a first data flow diagram in accordance with an embodiment is shown. The first data flow diagram may illustrate data used in and data processing performed in managing integration of a set of changes (e.g., set of changes 200) into a codebase for a software program (e.g., codebase 216).

To do so, set of changes 200 may be obtained for codebase 216. Codebase 216 may include source code for a software program, which may include a set of instructions and/or other code (e.g., written by programmers, software developers, and/or other users) for performing actions related to running the software program. Codebase 216 may include source code written in any programming language (e.g., Python, HTML, C++, Java).

Set of changes 200 may include potential changes to at least a portion of the source code included in codebase 216, which may be usable to obtain an updated version of the software program. For example, set of changes 200 may include a set of alterations for the at least the portion of the source code packaged together, and/or metadata regarding the set of alterations (e.g., a description of set of changes 200 provided by a user who wrote set of changes 200, an identifier for the user, a date set of changes 200 was written). Refer to the description of FIG. 1 for additional details regarding sets of changes for codebases.

Set of changes 200 may be used to perform set of changes analysis process 202 to obtain change magnitude 204. Change magnitude 204 may indicate a level of change to the source code should set of changes 200 be integrated into codebase 216. For example, the level of change may include a difference in functionality of the software program before and after integration of set of changes 200 (e.g., rather than a change in size of the source code). For example, obtaining a higher change magnitude 204 (e.g., based on a numerical and/or any other type of scale) may indicate integrating set of changes 200 into codebase 216 has an increased risk of undesired and/or unintended impacts on the updated version of the software program. For additional details regarding performing set of changes analysis process 202 and/or change magnitude 204, refer to the description of FIG. 2B.

For example, a data processing system (e.g., of data processing systems 104 described in FIG. 1) may include an antivirus software program. The antivirus software program may include functionalities for detecting malware on the data processing system. A first set of changes may be obtained for the antivirus software program including minor revisions to the source code intended to enhance readability of a portion of the source code. A change magnitude of 2 (e.g., on a scale of 1-10, where a change magnitude of 10 represents the highest level of change to the source code) may be obtained for the first set of changes. A second set of changes may be obtained for the antivirus software program intended to add functionality of the antivirus software program to remove detected malware from the data processing system. The second set of changes may include revising a larger portion of the source code relative to the first set of changes. As a result, a change magnitude of 8 may be obtained for the second set of changes. Thus, integrating the second set of changes into the codebase may have a higher risk of undesired impacts on the antivirus software program than integrating the first set of changes into the codebase.

Change magnitude 204 may then be used to perform criteria comparison process 206. During criteria comparison processes 206, a determination may be made regarding whether change magnitude 204 meets change magnitude criteria 208 (e.g., by an entity responsible for managing sets of changes for codebases, such as management system 102 described in FIG. 1). Change magnitude criteria 208 may be provided by a downstream consumer (e.g., obtained from any of data processing systems 104), a subject matter expert (SME), and/or any other entity participating in managing the integration of set of changes 200 into codebase 216. Change magnitude criteria 208 may include any number of thresholds, rule sets, and/or other means of determining whether a value of change magnitude 204 indicates set of changes 200 is permitted to be integrated into codebase 216.

For example, change magnitude criteria 208 may include a threshold value for change magnitude 204, and meeting the threshold value may indicate that integrating set of changes 200 into codebase 216 has an unacceptable risk of undesired impacts on the updated version of the software program.

For example, a set of changes for a codebase for a software program may be obtained, and the change magnitude for the set of changes may be calculated to be 85 on a scale of 1-100, where 1 indicates a lowest level of change to the source code, and 100 indicates a highest level of change to the source code. Change magnitude criteria for sets of changes to the software program may be set by a managing entity of the software program, such as a software company that produces the software program. The change magnitude criteria, for example, may indicate a threshold change magnitude of 50 to permit the set of changes to be integrated into the codebase. Therefore, in this example, the change magnitude would exceed the threshold change magnitude for the set of changes to be considered acceptable, and the set of changes would not meet the change magnitude criteria.

While described above with respect to a single quantity and a single corresponding threshold, it will be appreciated that any number of quantities may be compared to any number of corresponding thresholds and/or any other types of rules may be applied to determine whether change magnitude criteria 208 are met without departing from embodiments disclosed herein.

As a result of criteria comparison process 206, result 210 may be obtained. Result 210 may include an indication of whether change magnitude 204 meets change magnitude criteria 208. For example, result 210 may include: (i) a “yes” or “no” answer, (ii) change magnitude 204, (iii) a difference between change magnitude 204 and the threshold value included in change magnitude criteria 208, (iv) any other quantification of the level of change to the source code should set of changes 200 be integrated into codebase 216 based on change magnitude 204, and/or (v) other quantities and/or information.

Based on result 210, policy implementation process 212 may be performed. During policy implementation process 212, at least one action may be identified to manage integration of set of changes 200 into codebase 216 (e.g., by a management entity such as management system 102 shown in FIG. 1). Identifying the at least one action may include comparing a quantity and/or other information included as part of result 210 to policy 214. Policy 214 may include a policy, schema, and/or other type of rule set keyed to change magnitudes usable to determine actions to be performed based on change magnitudes for sets of changes. Policy 214 may be obtained from an SME, management entity of the software program, and/or any other entity that participates in managing integration of set of changes 200 into codebase 216.

For example, policy 214 may include a list of actions to be performed based on a value of change magnitude 204, such as: (i) obtaining a testing paradigm (e.g., principles, methodologies, practices, and/or other information regarding tests to be performed to reduce a likelihood of undesired impacts on the updated version of the software program) to be performed prior to integrating set of changes 200 into codebase 216, (ii) rejecting at least a portion of set of changes 200 to reduce a value of change magnitude 204, (iii) assigning, based on change magnitude 204, a user (e.g., of user devices 100 shown in FIG. 1) to review set of changes 200 prior to integrating set of changes 200 into codebase 216, and/or (iv) other actions.

Policy implementation process 212 may also include performing the at least one action to obtain the updated version of the software program to continue provision of the computer-implemented services. For example, if result 210 indicates change magnitude 204 meets change magnitude criteria 208 (e.g., integrating set of changes 200 into codebase 216 has an acceptable risk of undesired impacts on the updated version of the software program), the at least one action identified from policy 214 may include integrating set of changes 200 into codebase 216. By performing the at least one action, set of changes 200 may be integrated into codebase 216, and the updated version of the software program may be obtained. The updated version of the software program may then be used as part of providing the computer-implemented services.

Returning to the above example, a change magnitude of 85 may be obtained for a set of changes based on a scale of 0-100, which may exceed a threshold value of 50 included in the change magnitude criteria (e.g., the set of changes may not meet the change magnitude criteria). Based on a policy for integrating sets of changes into codebases keyed to change magnitudes and the change magnitude of 85, it may be determined that at least a portion of the set of changes is to be rejected to reduce the change magnitude. For example, a portion of the set of changes may be removed from the set of changes, which may result in the change magnitude being reduced to 45. Consequently, the set of changes may meet the change magnitude criteria, and the set of changes may be integrated into the codebase to obtain the updated version of the software program.

Turning to FIG. 2B, a second data flow diagram in accordance with an embodiment is shown. The second data flow diagram may illustrate data used in and data processing performed, at least in part, in performing an analysis process to obtain a change magnitude (e.g., change magnitude 204) for a set of changes (e.g., set of changes 200). FIG. 2B may be an expansion of set of changes analysis process 202 shown in FIG. 2A.

Performing the analysis process to obtain change magnitude 204 may include (i) obtaining, using set of changes 200 and codebase 216, criticality value 222 for set of changes 200, (ii) obtaining, using set of changes 200 and codebase 216, similarity value 226 for set of changes 200, (iii) obtaining, using at least criticality value 222 and/or similarity value 226, change magnitude 204, and/or (iv) performing other tasks to obtain change magnitude 204.

To obtain criticality value 222, criticality analysis process 220 may be performed. During criticality analysis process 220, a degree of impact of integrating set of changes 200 into codebase 216 may be evaluated. The degree of impact may be based on a number of application programming interfaces (APIs) impacted by set of changes 200.

To evaluate the degree of impact of integrating set of changes 200 into codebase 216, codebase 216 may be used to determine the number of APIs (e.g., of an API call chain) that would be impacted by integrating set of changes 200 into codebase 216. Determining the number of APIs that would be impacted may include: (i) identifying API calls within codebase 216 that would be impacted by set of changes 200, (ii) analyzing software dependencies to identify any external APIs that would be impacted by set of changes 200, (iii) analyzing API documentation used by the software program to identify APIs likely to be impacted by set of changes 200, and/or (iv) other methods. For example, the software program that is to be modified using set of changes 200 may impact an external API, which may impact an API call chain (e.g., originating from the external API). The degree of impact may be obtained based on a number of APIs in the API call chain associated with the external API impacted by set of changes 200. The degree of impact may include a value assigned based on any scale and/or rubric usable to indicate degrees of impact (e.g., a numerical scale, a letter scale, other types of scales).

Based on the degree of impact, criticality value 222 may be assigned to set of changes 200. For example, criticality value 222 may be assigned based on a schema, rule set, table, and/or other type data structure usable to assign criticality values to sets of changes based on degrees of impact. For example, criticality value 222 may include a value from 1-10, where a higher value indicates a larger number of APIs would be impacted by set of changes 200, and a lower value indicates fewer APIs would be impacted by set of changes 200.

To obtain similarity value 226, similarity analysis process 224 may be performed. During similarity analysis process 224, set of changes 200 and a trained machine learning model (e.g., a large language model (LLM) and/or other type of artificial intelligence model) may be used to obtain: (i) a first summary of set of changes 200, and (ii) a second summary of at least a portion of the source code that would be impacted by integrating set of changes 200 into codebase 216.

The first summary may include a description of the functionality, purpose, and/or other information regarding set of changes 200. The first summary may represent the at least the portion of the source code after integration of set of changes 200 into codebase 216. For example, the first summary may include human readable text generated by an LLM using set of changes 200 as ingest for the LLM.

The second summary may include a description of the functionality, purpose, and/or other information regarding the at least the portion of the source code. The second summary may represent the at least the portion of the source code prior to the integration of set of changes 200 into codebase 216. Obtaining the second summary may include methods similar to obtaining the first summary. For example, an LLM may be used to obtain the second summary, which may include human readable text generated using the at least the portion of the source code that would be impacted by set of changes 200 from codebase 216 as ingest for the LLM.

The first summary and the second summary may be compared to obtain a difference. Comparing the first summary and the second summary may include: (i) obtaining a first embedding (e.g., a numeric vector) for the first summary and a second embedding for the second summary (e.g., using an algorithm and/or other type of software program for converting a textual summary into a representative numeric vector), (ii) comparing the first embedding and the second embedding based on any method of comparing similarity of two embeddings (e.g., cosine similarity) to obtain a difference, and/or (iii) assigning similarity value 226 to set of changes 200 based on the difference. Similarity value 226 may include a value assigned based on any scale and/or rubric usable to indicate a degree of similarity between the source code before and after integration of set of changes 200 into codebase 216. By comparing the first embedding and the second embedding, changes to the functionality and/or meaning of the source code, rather than changes to size/length of the source code, may be evaluated.

While described with respect to obtaining similarity value 226 using embeddings of textual summaries, it will be appreciated that any other method for assessing similarity may be used without departing from embodiments disclosed herein. For example, similarity value 226 may be obtained by feeding the first summary and the second summary into an LLM, prompting the LLM to compare the first summary and the second summary, and obtaining the difference and/or similarity value 226 as output from the LLM.

Criticality value 222 and similarity value 226 may be used to perform change magnitude calculation process 228. During change magnitude calculation process 228, change magnitude 204 may be calculated based on criticality value 222 and similarity value 226. For example, change magnitude 204 may be calculated by obtaining a weighted sum of criticality value 222 and similarity value 226. Weights applied to criticality value 222 and similarity value 226 may be determined by an SME, a management entity, and/or any other entity that participates in managing integration of sets of changes into codebases (e.g., management system 102 shown in FIG. 1).

It will be appreciated that change magnitude 204 may be obtained, evaluated, and/or calculated using any other method, algorithm, and/or calculation without departing from embodiments disclosed herein.

Turning to FIG. 2C, a third data flow diagram in accordance with an embodiment is shown. The third data flow diagram may illustrate data used in and data processing performed, at least in part, evaluating a set of tasks to implement a modification to a codebase for software. Evaluating the set of tasks may include estimating a change magnitude for changes to the codebase required to complete the modification. Refer to FIG. 2B for details regarding calculation of change magnitudes.

To estimate a change magnitude associated with a set of tasks, change magnitude estimation process 232 may be performed. During change magnitude estimation process 232, at least set of tasks 230 may be used as ingest for machine learning model 234.

Set of tasks 230 may include one or more actions to be performed to modify functionality of software. Set of tasks 230 may be based on an updated functional specification for the software (not shown). The updated functional specification, for example, may indicate at least one functionality desired to be added to an updated version of the software and that is not available in an original version of the software. The updated functional specification may be obtained from any entity and/or generated via any methods without departing from embodiments disclosed herein (e.g., may be based on feedback from downstream consumers, may be generated by a management entity).

For example, set of tasks 230 may include: (i) adding a pop-up functionality to a GUI of the software, (ii) linking the pop-up functionality to a button on the GUI so that when a user of the software selects the button on the GUI, a pop-up window appears on the user’s device, (iii) displaying, via the pop-up window, text and/or images, and/or (iv) other tasks.

Set of tasks 230 may also include task descriptions. Each task description of the task descriptions may also include characteristics such as: (i) a number of words in the task, (ii) a number of bullet points in the task, (ii) a degree of nesting of the bullet points in the task, (iii) keywords included in the task, (iv) degrees of technical complexity associated with each of the keywords, (v) a number of link to other tasks of the set of tasks, and/or (vi) other characteristics.

Turning to FIG. 2D, an example task and task description are shown. Task 250 may include a set of tasks related to adding a pop-up functionality to a GUI on a software program. Task description 252 may include characteristics of task 250. For example, task 250 may include 63 words, 8 bullet points, a degree of nesting of bullet points of 3, 3 links to other tasks, and four keywords with associated degrees of technical complexity. The degree of nesting of 3 may be based on the sub-bullet points under the first bullet point and degrees of indentation of the sub-bullet points (e.g., “change font and font size” may be a third degree of indentation, “add username and password fields to pop-up window” may be a second degree of indentation).

The identified keywords (e.g., “pop-up window, button, check box, and font” may be generated via any methods (e.g., manually, automatically via an algorithm and/or rule set for matching keywords to a repository of previously identified keywords, via ingestion by an inference model trained to identify keywords). A previously populated repository of key words may include associated degrees of technical complexity for each keyword. A higher degree of technical complexity may indicate a task is more challenging (e.g., may require more computing resources, may require a programmer with a special skill set). The degrees of technical complexity may be represented via any methods (e.g., a scale of 1-10 with 1 being the lowest degree of technical complexity and 10 being the highest degree of technical complexity). For example, in task description 252, a “pop-up window” may be associated with a degree of technical complexity of 2 and “font” may be associated with a degree of technical complexity of 1.

The number of links to other tasks may indicate how many other tasks (e.g., other sets of tasks) depend on and/or are associated with task 250. If a task is associated with a higher number of other tasks, the technical complexity of performing the task may increase compared to a task associated with a lower number of other tasks, as performing the task may be constrained by requirements of the other tasks.

Returning to FIG. 2C, machine learning model 234 may include any type of artificial intelligence (AI) inference model (e.g., a neural network inference model) and may be trained using historical software update data to predict change magnitudes associated with ingested sets of tasks. The historical software update data may include descriptions of completed tasks and corresponding change magnitudes for software updated based on the completed tasks. The descriptions of the completed tasks may include characteristics of the completed tasks as described in FIG. 2C. The change magnitudes may have been calculated (e.g., via methods similar to those described in FIG. 2B and/or via other methods) after integration of the sets of changes generated by the completed tasks into codebases for software.

Therefore, during change magnitude estimation process 232, set of tasks 230 may be used as ingest for machine learning model 234 and change magnitude 236 may be obtained as an output from machine learning model 234. Change magnitude 236 may indicate an estimated level of change to operation of the software should the software be updated based on the modification to the codebase. Refer to FIGS. 2A-2B for additional details regarding change magnitudes.

Machine learning model 234 may include a generative AI model such as a large language model (LLM) trained to generate provisional sets of changes to the codebase based on sets of tasks. Machine learning model 234 may, therefore, be trained to generate language, understand language, and/or otherwise process requests related to languages. Machine learning model 234 may be trained using large training datasets to learn statistical relationships within text. Machine learning model 234 may be trained to generate inferences (e.g., responses, outputs) when provided with a prompt (e.g., ingest data). The inferences may include new instances of data created by the LLM based on learned associations from and/or an understanding of the training data. For example, the LLM may be trained using data such as codebases and sets of changes to codebases written in any coding language (e.g., C++, Python, Java) to generate inferences of the same.

Therefore, during change magnitude estimation process 232, machine learning model 234 may ingest a prompt based on set of tasks 230 and/or any amount of information from codebase 216 (e.g., the double-sided arrow connecting codebase 216 to change magnitude estimation process 232 indicates that codebase 216 may or may not be used during change magnitude estimation process 232). Machine learning model 234 may generate a provisional set of changes to the codebase (not shown). The provisional set of changes to the codebase may include potential changes to at least a portion of the codebase for the software usable to complete set of tasks 230.

The provisional set of changes may be used to obtain change magnitude 236. Obtaining change magnitude 236 based, at least in part, on the provisional set of changes may be performed via methods similar to those described in FIG. 2B with respect to using set of changes 200 to obtain change magnitude 204.

After obtaining change magnitude 236, it may be determined whether set of tasks 230 is acceptable using at least change magnitude 236 and software update criteria 240. To determine whether set of tasks 230 is acceptable, acceptability determination process 238 may be performed. Software update criteria 240 may include any policy, threshold, and/or other rule set for determining whether sets of tasks are acceptable using at least change magnitudes associated with the sets of tasks.

For example, during acceptability determination process 238, change magnitude 236 may be compared to a change magnitude threshold included in software update criteria 240 to obtain acceptability result 242. For example, change magnitude 236 may include a number between 0-100 with 0 indicating the least amount of impact on the operation of the software should the set of changes be integrated into the codebase and 100 indicating the largest amount of impact on the operation of the software should the set of changes be integrated into the codebase. Change magnitude 236 may include a quantity of 35.

The change magnitude threshold may include a corresponding quantity based on the scale of 0-100 and may be determined by a SME, by a user, and/or by any other entity via any methods (e.g., based on needs of downstream consumers) without departing from embodiments disclosed herein. The change magnitude threshold may, for example, include a threshold quantity of 50 and, in this example, change magnitude 236 may fall below the change magnitude threshold indicated by software update criteria 240.

Change magnitude 236 exceeding the change magnitude threshold may indicate that integrating the changes to the codebase may have an unacceptable risk of undesired impacts on instances of the software obtained from the integrated codebase.

Change magnitude 236 falling below the change magnitude threshold may indicate that set of tasks 230 are acceptable for use in updating the software.

If acceptability result 242 indicates that set of tasks 230 is acceptable, set of tasks 230 may be assigned (e.g., to programmers, engineers, other SMEs) and a set of changes may be obtained. Refer to FIG. 2A for additional details regarding integrating a set of changes into a codebase.

If acceptability result 242 indicates that set of tasks 230 is not acceptable, set of tasks 230 may be rejected for use in updating the software. If set of tasks 230 is rejected, one or more tasks of set of tasks 230 may be broken down into multiple sets of smaller tasks to increase a likelihood that a change magnitude for each individual set of tasks may fall below the change magnitude threshold. Doing so may reduce a likelihood of making changes to the codebase that may have an undesirably large impact on operation of the software thereby increasing a likelihood of providing desired computer-implemented services using, at least in part, the software.

Thus, by the implementing the processes illustrated in FIGS. 2A-2C, a system in accordance with embodiments disclosed herein may be used to manage integration of set of changes to source code into codebases based on change magnitudes for the sets of tasks usable to generate the sets of changes. The change magnitudes may be base on criticality and similarity values for the sets of changes. Consequently, a likelihood of introducing undesired impacts to the codebase may be reduced, and computer-implemented services may be provided as desired to downstream consumers.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to provide computer-implemented services using a data processing system. FIGS. 3A-3C illustrate methods that may be performed by the components of the system of FIG. 1. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method for providing computer-implemented services using a data processing system in accordance with an embodiment is shown. The method may be performed, for example, by any of the components of the system of FIG. 1, and/or any other entity without departing from embodiments disclosed herein.

At operation 300, a set of changes for a codebase may be obtained, the codebase including source code for a software program, and the set of changes including potential changes to the source code usable to obtain an updated version of the software program. Obtaining the set of changes may include: (i) reading the set of changes from storage, (ii) receiving the set of changes from another entity, (iii) generating the set of changes, and/or (iv) other methods.

Generating the set of changes may include: (i) identifying a modification that is to be made to at least a portion of the source code (e.g., to add functionalities to the software program, to improve security features, to fix errors in the source code), (ii) writing code that is to replace and/or be added to the source code to make the identified modification, (iii) packaging the code and/or metadata (e.g., including a description of the code, an identifier for a user who wrote the code, a date the code was written) to obtain the set of changes, and/or (iv) other methods.

At operation 302, an analysis process may be performed using the set of changes to obtain a change magnitude for the set of changes, the change magnitude indicating a level of change to the source code should the set of changes be integrated into the codebase. Performing the analysis process may include: (i) obtaining, using the set of changes and the codebase, a criticality value for the set of changes, (ii) obtaining, using the set of changes and the codebase, a similarity value for the set of changes, (iii) obtaining, using at least the criticality value and the similarity value, the change magnitude, (iv) providing the set of changes to another entity and receiving the change magnitude in response, and/or (v) other methods. Refer to the description of FIG. 3B for additional details regarding performing the analysis process.

At operation 304, a determination may be made, based on the change magnitude, regarding whether the change magnitude meets change magnitude criteria. Making the determination may include: (i) obtaining the change magnitude criteria, the change magnitude criteria including a threshold value for the change magnitude (e.g., receiving the change magnitude criteria from another entity, reading the change magnitude criteria from storage, generating the change magnitude criteria), (ii) comparing the change magnitude to the change magnitude criteria to obtain a result, (iii) providing the change magnitude to another entity and receiving an indication regarding whether the change magnitude meets the change magnitude criteria in response, and/or (iv) other methods.

Comparing the change magnitude to the change magnitude criteria may include methods similar to those described with respect to criteria comparison process 206 shown in FIG. 2A. For example, comparing the change magnitude to the change magnitude criteria may include: (i) comparing a quantity of the change magnitude to a quantity included in the change magnitude criteria (e.g., the threshold value and/or any other value) to obtain the result indicating whether the change magnitude meets the change magnitude criteria, (ii) comparing the quantity of the change magnitude to the quantity included in the change magnitude criteria to obtain other values, such as a difference between the change magnitude and the threshold value, and/or (iii) other methods.

At operation 306, at least one action may be identified to manage integration of the set of changes into the codebase based on the determination. Identifying the at least one action may include: (i) identifying, based on the change magnitude and a policy keyed to change magnitudes, the at least one action, (ii) providing the change magnitude and/or any other quantities to another entity and receiving the at least one action in response, and/or (iii) other methods.

Identifying the at least one action based on the change magnitude and a policy keyed to change magnitudes may include: (i) obtaining the policy (e.g., reading the policy from storage, receiving the policy from another entity, generating the policy), (ii) performing a search using the policy and the change magnitude as a key for the search to identify the at least one action, (iii) providing the change magnitude to another entity responsible for identifying the at least one action using the policy and receiving the at least one action in response, and/or (iv) other methods.

At operation 308, the at least one action may be performed to obtain the updated version of the software program to continue provision of the computer-implemented services. Performing the at least one action may include: (i) obtaining a testing paradigm to be performed prior to integrating the set of changes into the codebase (e.g., reading the testing paradigm from storage, receiving the testing paradigm from another entity, generating the testing paradigm), (ii) rejecting at least a portion of the set of changes to reduce the change magnitude (e.g., identifying the at least the portion of the set of changes to be rejected, removing the at least the portion of the set of changes from the set of changes, providing instructions to a user and/or other entity indicating that the at least the portion of the set of changes is to be removed from the set of changes), (iii) assigning, based on the change magnitude, a user to review the set of changes prior to integrating the set of changes into the codebase (e.g., identifying the user based on user skill level, experience, area of expertise, and/or other user characteristics, providing instructions to the user indicating that the user is to review the set of changes), (iv) integrating the set of changes into the codebase to obtain the updated version of the software program, (v) using the software program to facilitate provision of the computer-implemented services, and/or (vi) other methods.

The method may end following operation 308.

Turning to FIG. 3B, a second flow diagram illustrating a method for providing computer-implemented services using a data processing system in accordance with an embodiment is shown. The method may be performed, for example, by any of the components of the system of FIG. 1, and/or any other entity without departing from embodiments disclosed herein. The operations described in FIG. 3B may be an expansion of operation 302 shown in FIG. 3A.

At operation 320, a criticality value for the set of changes may be obtained using the set of changes and the codebase. Obtaining the criticality value may include: (i) evaluating a degree of impact of integrating the set of changes into the codebase, the degree of impact being based on a number of APIs impacted by the set of changes, (ii) assigning, based on the degree of impact, the criticality value, (iii) receiving the criticality value from another entity, (iv) reading the criticality value from storage, and/or (v) other methods.

Evaluating the degree of impact of integrating the set of changes into the codebase may include: (i) obtaining the number of APIs impacted by the set of changes, (ii) obtaining, based on the number of APIs, the degree of impact, (iii) receiving the degree of impact from another entity, and/or (iv) other methods.

Obtaining the number of APIs impacted by the set of changes may include: (i) identifying API calls within the codebase that would be impacted by the set of changes, (ii) analyzing software dependencies to identify any external APIs that would be impacted by the set of changes, (iii) analyzing API documentation used by the software program to identify APIs likely to be impacted by the set of changes, (iv) reading the number of APIs from storage, (v) receiving the number of APIs from another entity, and/or (vi) other methods.

Obtaining the degree of impact based on the number of APIs may include: (i) assigning the degree of impact based on the number of APIs (e.g., if the number of APIs is 20, the degree of impact may be 20), (ii) identifying the degree of impact using a schema, rule set, table, and/or other data structure usable to obtain degrees of impact based on the number of APIs, (iii) providing the number of APIs to another entity and receiving the degree of impact in response, and/or (iv) other methods.

Assigning the criticality value based on the degree of impact may include: (i) searching a schema, rule set, table, and/or other data structure using the degree of impact as a key for the search to identify the criticality value, (ii) providing the degree of impact to another entity and receiving the criticality value in response, and/or (iii) other methods.

At operation 322, a similarity value for the set of changes may be obtained using the set of changes and the codebase. Obtaining the similarity value may include: (i) obtaining, using the set of changes and a trained machine learning model, a first summary of the set of changes and a second summary of at least a portion of the source code that would be impacted by integrating the set of changes into the codebase, (ii) comparing the first summary and the second summary to obtain a difference, (iii) assigning, based on the difference, the similarity value, (iv) receiving the similarity value from another entity, (v) reading the similarity value from storage, and/or (vi) other methods.

Obtaining the first summary of the set of changes and the second summary of the at least the portion of the source code may include: (i) feeding the set of changes and the at least the portion of the source code into the trained machine learning model (e.g., an LLM) as ingest, (ii) prompting the trained machine learning model to summarize the set of changes and the at least the portion of the source code, (iii) obtaining the first summary and the second summary as output from the trained machine learning model, (iv) providing the set of changes and/or the at least the portion of the source code to another entity (e.g., that hosts and/or operates the trained machine learning model) and receiving the first summary and/or the second summary in response, and/or (v) other methods.

Comparing the first summary and the second summary to obtain the difference may include: (i) obtaining a first embedding (e.g., a numeric vector) for the first summary and a second embedding for the second summary (e.g., using an algorithm and/or other type of software program for converting a textual summary into a representative numeric vector), (ii) comparing the first embedding and the second embedding based on any method of comparing similarity of two embeddings (e.g., cosine similarity) to obtain the difference, (iii) feeding the first summary and the second summary to an LLM as ingest, (iv) prompting the LLM to compare the first summary and the second summary, (v) obtaining the difference as output from the LLM, (vi) providing the first summary and the second summary to another entity responsible for comparing the first summary and the second summary and receiving the difference in response, and/or (vii) other methods.

Assigning the similarity value based on the difference may include: (i) searching a schema, rule set, table, and/or other data structure using the difference as a key for the search to identify the similarity value, (ii) providing the difference to another entity and receiving the similarity value in response, and/or (iii) other methods.

At operation 324, the change magnitude may be obtained using at least the criticality value and the similarity value. Obtaining the change magnitude may include: (i) calculating the change magnitude using the criticality value and the similarity value, (ii) providing the criticality value and the similarity value to another entity and receiving the change magnitude in response, and/or (iii) other methods.

Calculating the change magnitude may include: (i) obtaining a weighted sum of the criticality value and the similarity value and using the weighted sum as the change magnitude, (ii) using any other algorithm and/or calculation to obtain the change magnitude using the criticality value and the similarity value, and/or (iii) other methods.

The method may end following operation 324.

Turning to FIG. 3C, a third flow diagram illustrating a method for providing computer-implemented services using a data processing system in accordance with an embodiment is shown. The method may be performed, for example, by any of the components of the system of FIG. 1, and/or any other entity without departing from embodiments disclosed herein.

Prior to operation 330, an identification may be made that an updated functional specification for the software is available. The updated functional specification may indicate at least one desired functionality for an updated version of the software. Making the identification may include: (i) receiving a notification from another entity (e.g., as a message over a communication system, as a message via an API) indicating the updated technical specification, (ii) reading the updated technical specification from storage, (iii) generating the updated technical specification (e.g., based on user feedback, based on feedback from a management entity), and/or (iv) other methods.

At operation 330, a set of tasks may be obtained to implement a modification to a codebase for software so that an updated version of the software based on the modified codebase has at least one desired functionality that is not available in an original version of the software. Obtaining the set of tasks may include: (i) reading the set of tasks from storage, (ii) receiving the set of tasks from another entity (e.g., via a message over a communication system, via a publish-subscribe system), (iii) generating the set of tasks (e.g., based on the updated technical specification), and/or (iv) other methods.

At operation 332, a change magnitude of changes to the codebase required to complete the modification may be estimated using at least one trained machine learning model. The change magnitude may indicate a level of change to operation of the software should the software be updated based on the modification to the codebase. Estimating the change magnitude may include: (i) obtaining task descriptions for the set of tasks, (ii) using the task descriptions as ingest for the at least one trained machine learning model to obtain the estimated change magnitude as an output from the at least one trained machine learning model, and/or (iii) other methods.

Obtaining the task descriptions for the set of tasks may include: (i) reading the task descriptions from storage, (ii) receiving the task descriptions from another entity, (iii) generating the task descriptions (e.g., using any algorithm, rule set, and/or another trained machine learning model), and/or (iv) other methods.

Using the task descriptions as ingest for the at least one machine learning model may include: (i) feeding the task descriptions into the at least one machine learning model, (ii) providing the task descriptions to another entity responsible for operating the at least one machine learning model and receiving the estimated change magnitude from the entity, and/or (iii) other methods.

Estimating the change magnitude may also include: (i) obtaining, using the set of tasks as input for an LLM (e.g., in an instance where the at least one trained machine learning model includes an LLM), a provisional set of changes to the codebase as an output from the LLM, (ii) obtaining, based on the provisional set of changes, the estimated change magnitude, and/or (iii) other methods.

Obtaining the provisional set of changes may include: (i) generating a prompt for the LLM using the set of tasks, (ii) providing the prompt as ingest for the LLM, (iii) providing additional information (e.g., access to a codebase for the software) as context for the LLM, (iv) providing the set of tasks to another entity responsible for operating LLM and receiving the provisional set of changes from the entity, and/or (iii) other methods.

Obtaining the estimated change magnitude may include methods similar to those described in operation 302 of FIG. 3A and the corresponding expansion of operation 302 in FIG. 3B.

At operation 334, it may be determined whether the set of tasks is acceptable using the estimated change magnitude and software update criteria. Making the determination may include: (i) obtaining a change magnitude threshold from the software update criteria, (ii) comparing a quantity from the change magnitude to a corresponding quantity from the change magnitude threshold, (iii) providing the change magnitude and the change magnitude threshold to another entity responsible for comparing the change magnitude to the change magnitude threshold, (iv) utilizing a policy for change magnitude acceptability included in the software update criteria, and/or (v) other methods.

If the change magnitude falls below the change magnitude threshold, it may be determined that the set of tasks is acceptable. If the change magnitude exceeds the change magnitude threshold, it may be determined that the set of tasks is not acceptable. Determining whether the set of tasks is acceptable may include other methods based on other thresholds and/or other aspects of the software update criteria without departing from embodiments disclosed herein.

If the set of changes is acceptable, the method may proceed to operation 336. At operation 336, an update process for the software may be initiated based on the set of tasks to obtain the updated software. Initiating the update process may include: (i) assigning the set of tasks to any number of programmers, engineers, and/or other SMEs and obtaining a set of changes in response to the assigned tasks, (ii) generating at least a portion of the set of changes based on the set of tasks, (iii) integrating the set of changes into the codebase for the software to obtain the updated software, (iv) providing the set of changes to another entity responsible for integrating the set of changes into the codebase, and/or (v) other methods.

Integrating the set of changes into the codebase may include: (i) modifying the codebase (e.g., adding portions of code, removing portions of code, modifying portions of code) to generate the updated codebase, (ii) providing the set of changes to another entity responsible for generating the updated codebase, and/or (iii) other methods.

At operation 338, the updated software may be deployed to facilitate provisioning of desired computer-implemented services. Deploying the software may include: (i) identifying a target for deployment (e.g., a target location such as a server and/or a data processing system, a target downstream consumer), (ii) making an instance of the software available at the target (e.g., saving an instance of the integrated codebase in a particular location on a server, providing an instance of the integrated codebase to a downstream consumer), and/or (iii) other methods.

The method may end following operation 338.

Returning to operation 334, the method may proceed to operation 340 if the set of tasks is determined to not be acceptable.

At operation 340, the set of tasks may be rejected for use in updating the software. Rejecting the set of tasks may include: (i) not assigning any of the set of tasks, (ii) not generating a set of changes based on the set of tasks, (iii) providing a notification (e.g., to an SME) that the set of tasks is not to be completed, (iii) initiating one or more actions to modify the set of tasks (e.g., breaking down one or more of the set of tasks into individual sets of tasks) to increase a likelihood that change magnitudes for the individual sets of tasks may meet the software update criteria, and/or (iv) other methods.

The method may end following operation 340.

Thus, as illustrated above, embodiments disclosed herein may provide systems and methods usable to manage integration of sets of changes into codebases for software programs in a manner that reduces a likelihood of negatively impacting the software programs. Consequently, computer-implemented services provided using the software programs may be provided as desired by downstream consumers of the computer-implemented services.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows^{®} operating system from Microsoft^{®}, Mac OS^{®}/iOS^{®} from Apple, Android^{®} from Google^{®}, Linux^{®}, Unix^{®}, or other real-time or embedded operating systems such as VxWorks.

System 400 may further include IO devices such as devices (e.g., 405, 406, 407,408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using a data processing system, the method comprising:
obtaining a set of tasks to implement a modification to a codebase for software so that an updated version of the software based on the modified codebase has at least one desired functionality that is not available in an original version of the software;
estimating, using the set of tasks and at least one trained machine learning model, a change magnitude of changes to the codebase required to complete the modification, the estimated change magnitude indicating a level of change to operation of the software should the software be updated based on the modification to the codebase;
making a determination, using the estimated change magnitude and software update criteria, regarding whether the set of tasks is acceptable;
in a first instance of the determination in which the set of tasks is acceptable:
initiating, based on the set of tasks, an update process for the software to obtain the updated version of the software; and
deploying the updated version of the software to facilitate provisioning of desired computer-implemented services.

2. The method of claim 1, further comprising:
in a second instance of the determination in which the set of tasks is not acceptable:
rejecting the set of tasks for use in updating the software.

3. The method of claim 1, wherein estimating the change magnitude comprises:
obtaining task descriptions for the set of tasks; and
using the task descriptions as ingest for the at least one trained machine learning model to obtain the estimated change magnitude as an output from the at least one trained machine learning model.

4. The method of claim 3, wherein each task description of the task descriptions comprises at least one characteristic selected from a list of characteristics consisting of:
a number of words in a task of the set of tasks;
a number of bullet points in the task;
a degree of nesting of the bullet points in the task;
keywords included in the task;
degrees of technical complexity associated with each of the keywords; and
a number of links to other tasks of the set of tasks.

5. The method of claim 3, wherein the trained machine learning model is trained using historical software update data, the historical software update data comprising descriptions of completed tasks and corresponding change magnitudes for software updated based on the completed tasks.

6. The method of claim 1, wherein the trained machine learning model is a large language model (LLM) trained to generate provisional sets of changes to the codebase based on sets of tasks.

7. The method of claim 6, wherein estimating the change magnitude comprises:
obtaining, using the set of tasks as input for the LLM, a provisional set of changes to the codebase as an output from the LLM, the provisional set of changes being usable to complete the set of tasks; and
obtaining, based on the provisional set of changes, the estimated change magnitude.

8. The method of claim 7, wherein the provisional set of changes comprises potential changes to at least a portion of the codebase usable to complete the set of tasks.

9. The method of claim 1, wherein the software update criteria comprise a change magnitude threshold.

10. The method of claim 9, wherein the change magnitude exceeding the change magnitude threshold indicates integrating the changes to the codebase required to complete the modification has an unacceptable risk of undesired impacts on instances of the software obtained from the integrated codebase.

11. The method of claim 1, wherein the change magnitude is a weighted sum of a criticality value and a similarity value.

12. The method of claim 11, wherein the criticality value indicates a degree of impact of integrating the changes into the codebase, the degree of impact being based on a number of application programming interfaces (APIs) impacted by the changes.

13. The method of claim 11, wherein the similarity value is based on a difference between a first summary of the changes and a second summary of the at least a portion of codebase for the software.

14. The method of claim 1, wherein the codebase comprises source code for the software.

15. The method of claim 1, further comprising:
prior to obtaining the set of tasks:
making an identification that an updated functional specification is available for the software, the updated functional specification indicating the at least one desired functionality.

16. A non-transitory machine-readable medium having instructions stored therein, which when executed by a processor, cause the processor to perform operations for providing computer-implemented services using a data processing system, the operations comprising:
obtaining a set of tasks to implement a modification to a codebase for software so that an updated version of the software based on the modified codebase has at least one desired functionality that is not available in an original version of the software;
estimating, using the set of tasks and at least one trained machine learning model, a change magnitude of changes to the codebase required to complete the modification, the estimated change magnitude indicating a level of change to operation of the software should the software be updated based on the modification to the codebase;
making a determination, using the estimated change magnitude and software update criteria, regarding whether the set of tasks is acceptable;
in a first instance of the determination in which the set of tasks is acceptable:
initiating, based on the set of tasks, an update process for the software to obtain the updated version of the software; and
deploying the updated version of the software to facilitate provisioning of desired computer-implemented services.

17. The non-transitory machine-readable medium of claim 16, wherein the operations further comprise:
in a second instance of the determination in which the set of tasks is not acceptable:
rejecting the set of tasks for use in updating the software.

18. The non-transitory machine-readable medium of claim 16, wherein estimating the change magnitude comprises:
obtaining task descriptions for the set of tasks; and
using the task descriptions as ingest for the at least one trained machine learning model to obtain the estimated change magnitude as an output from the at least one trained machine learning model.

19. A data processing system, comprising:
a processor; and
a memory coupled to the processor to store instructions, which when executed by the processor, cause the processor to perform operations for providing computer-implemented services using a data processing system, the operations comprising:
obtaining a set of tasks to implement a modification to a codebase for software so that an updated version of the software based on the modified codebase has at least one desired functionality that is not available in an original version of the software;
estimating, using the set of tasks and at least one trained machine learning model, a change magnitude of changes to the codebase required to complete the modification, the estimated change magnitude indicating a level of change to operation of the software should the software be updated based on the modification to the codebase;
making a determination, using the estimated change magnitude and software update criteria, regarding whether the set of tasks is acceptable;
in a first instance of the determination in which the set of tasks is acceptable:
initiating, based on the set of tasks, an update process for the software to obtain the updated version of the software; and
deploying the updated version of the software to facilitate provisioning of desired computer-implemented services.

20. The data processing system of claim 19, wherein the operations further comprise:
in a second instance of the determination in which the set of tasks is not acceptable:
rejecting the set of tasks for use in updating the software.
